(19) United States
(12) Patent Application Publication
(10) Pub. No.: US 2023/0098208 A1
(43) Pub. Date: Mar. 30, 2023

(54) WRAPAROUND STRUCTURE FOR A BELT PACKAGE OF A TIRE

(71) Applicant: The Goodyear Tire & Rubber Company, Akron, OH (US)

(72) Inventors: Olivier Guy Jacques, Mertzig (LU); Nigel Carl Hosker, Grevenknapp (LU); Hendrikus Lambertus Johannes Maria De Wit, Diekirch (LU)

(21) Appl. No.: 17/490,335

(22) Filed: Sep. 30, 2021

(51) Int. Cl. B60C 9/18

(52) U.S. Cl. CPC B60C 9/1835; B60C 2009/1864

(57) ABSTRACT

A tire includes a carcass ply and a belt structure disposed radially outward of the carcass ply in a crown portion of the tire. The belt structure includes a first belt ply, a second belt ply radially adjacent the first belt ply, an overlay ply radially adjacent the first belt ply, a first wrap around strip encompassing both axial edges of the first belt ply, and a second wrap around strip encompassing both axial edges of the second belt ply. The overlay ply may have an axial width less than both a maximum axial width of the first belt ply and a maximum axial width of the second belt ply.

### FIELD OF THE INVENTION

The present invention is directed towards a pneumatic or a non-pneumatic tire. More specifically, the present invention is directed towards a belt package for a tire wherein a wraparound structure for belt package improves tire durability and tread wear uniformity.

### BACKGROUND OF THE INVENTION

A continuing goal of the tire industry is the improvement of the performance of tires. Desirable characteristics for tires may be light weight, low drag, good traction, minimal runout, low noise, good handling, low treadwear, and/or low rolling resistance. Further, the tire industry strives for tire constructions well-suited for specific conditions and uses. Optimization of handling using one construction, and high speed durability using another construction, may be one method for addressing a specific condition. Light weight tires with improved and/or maintained physical properties and optimization for different conditions are desirable goals for tire designers.

### Definitions

“Apex” means an elastomeric filler located radially above the bead core and between the plies and the turnup ply.

“Annular” means formed like a ring.

“Aspect ratio” means the ratio of its section height to its section width.

“Axial” and “axially” are used herein to refer to lines or directions that are parallel to the axis of rotation of the tire.

“Bead” means that part of the tire comprising an annular tensile member wrapped by ply cords and shaped, with or without other reinforcement elements such as flippers, chippers, apexes, toe guards and chafers, to fit the design rim.

“Belt structure” means at least two annular layers or plies of parallel cords, woven or unwoven, underlying the tread, unanchored to the bead, and having cords inclined respect to the equatorial plane of the tire. The belt structure may also include plies of parallel cords inclined at relatively low angles, acting as restricting layers.

“Bias tire” (cross ply) means a tire in which the reinforcing cords in the carcass ply extend diagonally across the tire from bead to bead at about a 25°-65° angle with respect to equatorial plane of the tire. If multiple plies are present, the ply cords run at opposite angles in alternating layers.

“Breakers” means at least two annular layers or plies of parallel reinforcement cords having the same angle with reference to the equatorial plane of the tire as the parallel reinforcing cords in carcass plies. Breakers are usually associated with bias tires.

“Cable” means a cord formed by twisting together two or more plied yarns.

“Carcass” means the tire structure apart from the belt structure, tread, undertread, and sidewall rubber over the plies, but including the beads.

“Casing” means the carcass, belt structure, beads, sidewalls and all other components of the tire excepting the tread and undertread, i.e., the whole tire.

“Chipper” refers to a narrow band of fabric or steel cords located in the bead area whose function is to reinforce the bead area and stabilize the radially inwardmost part of the sidewall.

“Circumferential” means lines or directions extending along the perimeter of the surface of the annular tire parallel to the Equatorial Plane (EP) and perpendicular to the axial direction; it can also refer to the direction of the sets of adjacent circular curves whose radii define the axial curvature of the tread, as viewed in cross section.

“Cord” means one of the reinforcement strands of which the reinforcement structures of the tire are comprised.

“Cord angle” means the acute angle, left or right in a plan view of the tire, formed by a cord with respect to the equatorial plane. The “cord angle” is measured in a cured but uninflated tire.

“Crown area” means that portion of the tire within the width limits of the tire tread.

“Denier” means the weight in grams per 9000 meters (unit for expressing linear density). Dtex means the weight in grams per 10,000 meters.

“Density” means weight per unit length.

“Elastomer” means a resilient material capable of recovering size and shape after deformation.

“Equatorial plane (EP)” means the plane perpendicular to the tire's axis of rotation and passing through the center of its tread; or the plane containing the circumferential centerline of the tread.

“Fabric” means a network of essentially unidirectionally extending cords, which may be twisted, and which in turn are composed of a plurality of a multiplicity of filaments (which may also be twisted) of a high modulus material.

“Fiber” is a unit of matter, either natural or man-made that forms the basic element of filaments. Characterized by having a length at least 100 times its diameter or width.

“Filament count” means the number of filaments that make up a yarn. Example: 1000 denier polyester has approximately 190 filaments.

“Flipper” refers to a reinforcing fabric around the bead wire for strength and to tie the bead wire in the tire body.

“Gauge” refers generally to a measurement, and specifically to a thickness measurement.

“High tensile steel (HT)” means a carbon steel with a tensile strength of at least 3400 MPa at 0.20 mm filament diameter.

“Inner” means toward the inside of the tire and “outer” means toward its exterior.

“Innerliner” means the layer or layers of elastomer or other material that form the inside surface of a tubeless tire and that contain the inflating fluid within the tire.

“LASE” is load at specified elongation.

“Lateral” means an axial direction.

“Lay length” means the distance at which a twisted filament or strand travels to make a 360 degree rotation about another filament or strand.

“Load range” means load and inflation limits for a given tire used in a specific type of service as defined by tables in The Tire and Rim Association, Inc.

“Mega tensile steel (MT)” means a carbon steel with a tensile strength of at least 4500 MPa at 0.20 mm filament diameter.

“Normal Load” means the specific design inflation pressure and load assigned by the appropriate standards organization for the service condition for the tire.

“Normal tensile steel (NT)” means a carbon steel with a tensile strength of at least 2800 MPa at 0.20 mm filament diameter.

“Ply” means a cord-reinforced layer of rubber-coated radially deployed or otherwise parallel cords.

“Radial” and “radially” are used to mean directions radially toward or away from the axis of rotation of the tire.

“Radial ply structure” means the one or more carcass plies or which at least one ply has reinforcing cords oriented at an angle of between 65° and 90° with respect to the equatorial plane of the tire.

“Radial ply tire” means a belted or circumferentially-restricted pneumatic tire in which at least one ply has cords which extend from bead to bead are laid at cord angles between 65° and 90° with respect to the equatorial plane of the tire.

“Rivet” means an open space between cords in a layer.

“Section Height” means the radial distance from the nominal rim diameter to the outer diameter of the tire at its equatorial plane.

“Section width” means the maximum linear distance parallel to the axis of the tire and between the exterior of its sidewalls when and after it has been inflated at normal pressure for 24 hours, but unloaded, excluding elevations of the sidewalls due to labeling, decoration or protective bands.

“Sidewall” means that portion of a tire between the tread and the bead.

“Stiffness ratio” means the value of a control belt structure stiffness divided by the value of another belt structure stiffness when the values are determined by a fixed three point bending test having both ends of the cord supported and flexed by a load centered between the fixed ends.

“Super tensile steel (ST)” means a carbon steel with a tensile strength of at least 3650 MPa at 0.20 mm filament diameter.

“Tenacity” is stress expressed as force per unit linear density of the unstrained specimen (gm/tex or gm/denier). Used in textiles.

“Tensile” is stress expressed in forces/cross-sectional area. Strength in psi=12,800 times specific gravity times tenacity in grams per denier.

“Toe guard” refers to the circumferentially deployed elastomeric rim-contacting portion of the tire axially inward of each bead.

“Tread” means a molded rubber component which, when bonded to a tire casing, includes that portion of the tire that comes into contact with the road when the tire is normally inflated and under normal load.

“Tread width” means the arc length of the tread surface in a plane including the axis of rotation of the tire.

“Turnup end” means the portion of a carcass ply that turns upward (i.e., radially outward) from the beads about which the ply is wrapped.

“Ultra tensile steel (UT)” means a carbon steel with a tensile strength of at least 4000 MPa at 0.20 mm filament diameter.

“Yarn” is a generic term for a continuous strand of textile fibers or filaments. Yarn occurs in the following forms: 1) a number of fibers twisted together; 2) a number of filaments laid together without twist; 3) a number of filaments laid together with a degree of twist; 4) a single filament with or without twist (monofilament); 5) a narrow strip of material with or without twist.

### SUMMARY OF THE INVENTION

A tire in accordance with the present invention includes a carcass ply and a belt structure disposed radially outward of the carcass ply in a crown portion of the tire. The belt structure includes a first belt ply, a second belt ply radially adjacent the first belt ply, an overlay ply radially adjacent the first belt ply, a first wrap around strip encompassing both axial edges of the first belt ply, and a second wrap around strip encompassing both axial edges of the second belt ply.

According to another aspect of the tire, the overlay ply has an axial width less than a maximum axial width of the first belt ply and a maximum axial width of the second belt ply.

According to still another aspect of the tire, the first wrap around strip includes reinforcing cords.

According to yet another aspect of the tire, the second wrap around strip includes reinforcing cords.

According to still another aspect of the tire, the first wrap around strip includes reinforcing fibers.

According to yet another aspect of the tire, the second wrap around strip includes reinforcing fibers.

According to still another aspect of the tire, the first wrap around strip includes reinforcing fabric.

According to yet another aspect of the tire, the second wrap around strip includes reinforcing fabric.

According to still another aspect of the tire, radially outer portions of the first wrap around strips axially overlap axially outer edges of the overlay ply.

According to yet another aspect of the tire, radially inner portions of the first wrap around strips axially overlap radially outer portions of the second wrap around gum strips.

A method in accordance with the present invention reinforces a crown area of a tire. The method includes the steps of: extending a carcass ply from a first bead portion to a second bead portion; placing a belt structure radially outward of the carcass ply in the crown area of the tire, the belt structure including a first belt ply, a second belt ply, an overlay ply, a first wrap around strip, and a second wrap around strip; encompassing each axial edge of the first belt ply with a first wrap around strip; encompassing each axial edge of the second belt ply with a second wrap around strip; axially overlapping each axial edge of the overlay ply with a radially outer portion of the first wrap around strip; and axially overlapping a radially inner portion of a first wrap around strip with a radially outer portion of the second wrap around strip.

According to another aspect of the method, the overlay ply has an axial width less than both a maximum axial width of the first belt ply and a maximum axial width of the second belt ply.

According to still another aspect of the method, the first wrap around strip includes reinforcing cords.

According to yet another aspect of the method, the second wrap around strip includes reinforcing cords.

According to still another aspect of the method, the first wrap around strip includes reinforcing fibers.

According to yet another aspect of the method, the second wrap around strip includes reinforcing fibers.

According to still another aspect of the method, the first wrap around strip includes reinforcing fabric.

According to yet another aspect of the method, the second wrap around strip includes reinforcing fabric.

According to still another aspect of the method, radially outer portions of the first wrap around strips directly contact axially outer edges of the overlay ply.

According to yet another aspect of the method, radially inner portions of the first wrap around strips directly contact radially outer portions of the second wrap around gum strips.

### BRIEF DESCRIPTION OF THE DRAWINGS

The invention will be described by way of example and with reference to the accompanying drawings in which:

FIG. 1 is a schematic cross sectional view of an example tire for use with the present invention; and

FIG. 2 is a schematic detailed sectional view of the tire of FIG. 1 in accordance with the present invention.

### DETAILED DESCRIPTION OF EXAMPLES OF THE PRESENT INVENTION

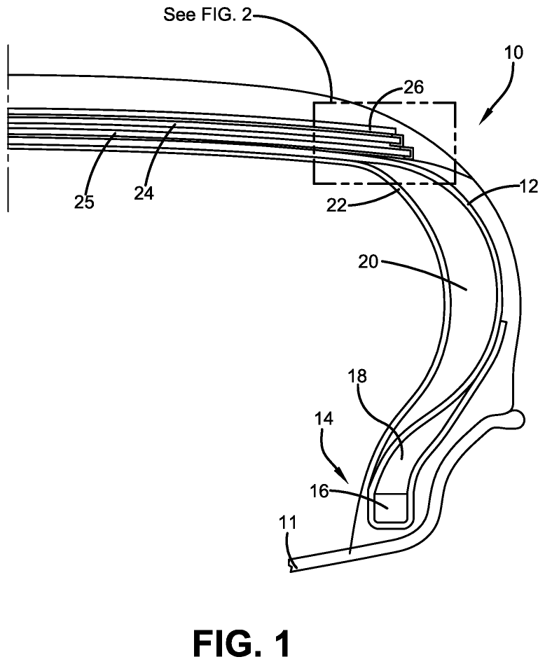

FIG. 1 is a cross-sectional view of an example tire 10, mounted on a tire rim 11, designed to be capable of continued operation during inflated, under-inflated, and deflated conditions. One half of the cross-sectional view of the example tire 10 is shown, it being understood that, the other half may be a mirror image of that which is illustrated in FIG. 1. The example tire 10 may have at least one carcass reinforcing ply 12 extending from one bead area 14 of the tire to an opposing bead area (not shown). The ends of the reinforcing ply 12 may be turned axially inward to axially outward about bead cores 16 and bead apexes 18. The terminal ends of the reinforcing ply 12 may extend past the radially outer ends of the bead apexes 18 thereby enveloping the bead apexes.

Located in each sidewall region of the example tire 10 may be a sidewall insert 20. The insert 20 may be located adjacent to the tire innerliner 22 or axially outward of the reinforcing ply 12. The insert 20 may be formed of elastomeric material and may extend from the crown area, such as from radially inward of a belt structure 24, 25 to radially inward of the outermost terminal end of the bead apexes 18 that overlap the bead apexes 18. The elastomeric material of the insert 20 may be selected to provide the example tire 10 with support during underinflated and deflated operation of the tire.

In the crown area of the example tire 10, the belt structure 24, 25 may be located radially outward of the carcass ply 12. The belt structure 24, 25 may have at least two inclined, crossed cord belt plies 24, 25 and an overlay ply 26. The cords may be inclined with respect to the circumferential direction of the example tire 10 in a first belt ply 24 and the cords in a second belt ply 25 directly adjacent the first belt ply 24 may be inclined at similar, but opposing, angles to the cords in the first belt ply 24. Radially outward of the crossed cord belt plies 24, 25 may be the overlay ply 26. The overlay ply 26 may have a width equal to, or less than, the maximum width of the crossed cord plies 24, 25. The overlay ply 26 may be reinforced with cords inclined at angles between of 15° and −15° with respect to the circumferential direction of the example tire 10.

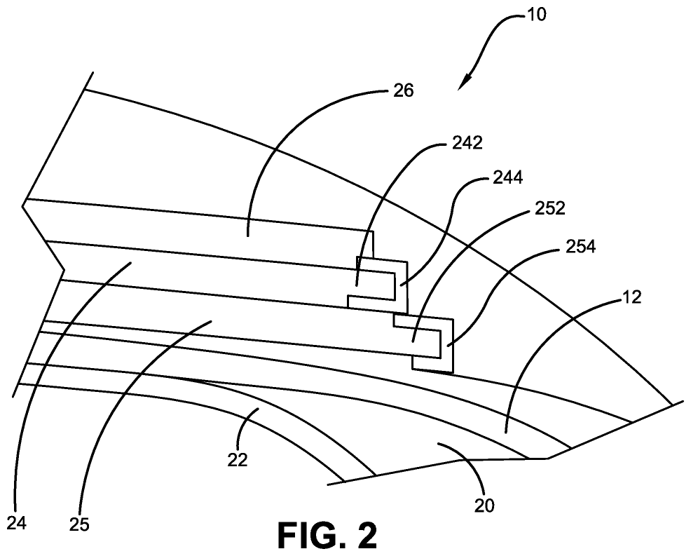

In accordance with the present invention, the overlay ply 26 may have a width less than a maximum width of the crossed cord plies of the belt structure 24, 25 (FIGS. 1-2). Edges 242 of the first belt ply 24 may be encompassed by first wrap around gum strips 244 (one shown). Edges 252 of the second belt ply 25 may be encompassed by second wrap around gum strips 254 (one shown). The first and second wrap around gum strips 244, 254 may or may not include reinforcement structures such as cords, fibers, short fibers, fabric, etc. Such a belt/overlay construction 24, 25, 26, 244, 254 may mitigate material flow in this area and thereby prevent cords of the second belt ply 25 from directly contacting cords of the first belt ply 24 and cords of the first belt ply 24 from directly contacting cords of the overlay ply 26 thereby increasing durability of the crown area.

As shown in FIG. 2, axially outer edges of the overlay ply 26 may axially overlap a radially outer portion of each first wrap around gum strip 244. A radially inner portion of the first wrap around gum strips 244 may axially overlap a radially outer portion of each second wrap around gum strip 254. These overlaps may further reinforce the axially outer edges of the crown area of the tire 10.

The above description is of the best presently contemplated mode or modes of carrying out the present invention. This description is made for the purpose of illustrating an example of general principles of the present invention and should not be interpreted as limiting the present invention. The scope of the present invention is best determined by reference to the appended claims. The reference numerals as depicted in the schematic drawings are the same as those referred to in the specification. For purposes of this application, the various examples illustrated in the figures each use same reference numerals for similar components. The example structures may employ similar components with variations in location or quantity thereby giving rise to alternative constructions in accordance with the present invention.

What is claimed:

1. A tire comprising:
a carcass ply; and
a belt structure disposed radially outward of the carcass ply in a crown portion of the tire, the belt structure including a first belt ply, a second belt ply radially adjacent the first belt ply, an overlay ply radially adjacent the first belt ply, a first wrap around strip encompassing both axial edges of the first belt ply, and a second wrap around strip encompassing both axial edges of the second belt ply.

2. The tire as set forth in claim 1 wherein the overlay ply has an axial width less than a maximum axial width of the first belt ply and a maximum axial width of the second belt ply.

3. The tire as set forth in claim 1 wherein the first wrap around strip includes reinforcing cords.

4. The tire as set forth in claim 1 wherein the second wrap around strip includes reinforcing cords.

5. The tire as set forth in claim 1 wherein the first wrap around strip includes reinforcing fibers.

6. The tire as set forth in claim 1 wherein the second wrap around strip includes reinforcing fibers.

7. The tire as set forth in claim 1 wherein the first wrap around strip includes reinforcing fabric.

8. The tire as set forth in claim 1 wherein the second wrap around strip includes reinforcing fabric.

9. The tire as set forth in claim 1 wherein radially outer portions of the first wrap around strips axially overlap axially outer edges of the overlay ply.

10. The tire as set forth in claim 1 wherein radially inner portions of the first wrap around strips axially overlap radially outer portions of the second wrap around gum strips.

11. A method for reinforcing a crown area of a tire comprises the steps of:
extending a carcass ply from a first bead portion to a second bead portion;
placing a belt structure radially outward of the carcass ply in the crown area of the tire, the belt structure including a first belt ply, a second belt ply, an overlay ply, a first wrap around strip, and a second wrap around strip;
encompassing each axial edge of the first belt ply with a first wrap around strip;
encompassing each axial edge of the second belt ply with a second wrap around strip;
axially overlapping each axial edge of the overlay ply with a radially outer portion of the first wrap around strip; and
axially overlapping a radially inner portion of a first wrap around strip with a radially outer portion of the second wrap around strip.

12. The method as set forth in claim 11 wherein the overlay ply has an axial width less than both a maximum axial width of the first belt ply and a maximum axial width of the second belt ply.

13. The method as set forth in claim 11 wherein the first wrap around strip includes reinforcing cords.

14. The method as set forth in claim 11 wherein the second wrap around strip includes reinforcing cords.

15. The method as set forth in claim 11 wherein the first wrap around strip includes reinforcing fibers.

16. The method as set forth in claim 11 wherein the second wrap around strip includes reinforcing fibers.

17. The method as set forth in claim 11 wherein the first wrap around strip includes reinforcing fabric.

18. The method as set forth in claim 11 wherein the second wrap around strip includes reinforcing fabric.

19. The method as set forth in claim 11 wherein radially outer portions of the first wrap around strips directly contact axially outer edges of the overlay ply.

20. The method as set forth in claim 11 wherein radially inner portions of the first wrap around strips directly contact radially outer portions of the second wrap around gum strips.
